(19) United States
(12) Patent Application Publication
(10) Pub. No.: US 2026/0022747 A1
(43) Pub. Date: Jan. 22, 2026

(54) BRAKE ASSEMBLY FOR WORK MACHINE

(71) Applicant: Caterpillar Inc., Peoria, IL (US)

(72) Inventors: Anushya Sambamoorthy, Chennai (IN); K V Deepak, Chennai (IN); Shinya Sono, Naperville, IL (US)

(73) Assignee: Caterpillar Inc., Peoria, IL (US)

(21) Appl. No.: 18/776,347

(22) Filed: Jul. 18, 2024

(51) Int. Cl. F16D 65/18; B60T 1/06; F16D 55/40; F16D 121/04

(52) U.S. Cl. CPC F16D 65/18; B60T 1/062; F16D 55/40; B60Y 2200/41; F16D 2121/04

(57) ABSTRACT

A brake assembly for a work machine includes a main brake housing, a disc stack, a brake housing coupled with the main brake housing, and a piston to compress the disc stack. At least one of the main brake housing and the piston define at least two spring pockets. The at least two spring pockets are circumferentially spaced apart from each other. The brake assembly also includes at least two spring assemblies disposed between the main brake housing and the piston. The at least two spring assemblies are adapted to engage the piston with the disc stack to apply brakes via the brake assembly. Each spring pocket of the at least two spring pockets receives a corresponding spring assembly of the at least two spring assemblies. Each of the at least two spring assemblies includes at least one Belleville spring.

### TECHNICAL FIELD

The present disclosure relates to a work machine, an axle assembly for the work machine, and a brake assembly for the work machine.

### BACKGROUND

A work machine, such as a mining truck, is often required to operate on steep gradients and under heavy loads. The work machine includes a brake assembly that is used to apply service brakes and/or park brakes. The brake assembly includes a disc stack, a piston, such as, a service piston and/or a park piston, and one or more coil springs. The disc stack includes a number of friction plates and a number of separator plates interleaved with the number of friction plates. The one or more coil springs may provide a braking force to apply the brakes to halt the work machine. The coil springs urge the piston towards the disc stack, thereby compressing the disc stack.

Further, in order to meet regulations and standards of braking requirements, such as, grade holding, stopping distance, deceleration, and the like, current brake assemblies require increase in load by the coil springs to meet the required braking force. Furthermore, during a braking operation, the number of friction plates in the disc stack may wear which results in reduction in a thickness of the disc stack. In such a worn state of the brake assembly, retract pressure and touch-up pressure requirements may increase as more braking force may be required to compress the disc stack. In order to meet the braking requirements in such instances, additional coil springs may be required. However, increasing the number of coil springs may not be feasible as current brake assemblies have packaging constraints, that prevents accommodation of additional coil springs within the brake assembly.

U.S. Pat. No. 9,915,305 describes a friction drive arrangement includes a plurality of interleaved rotor and stator discs. An end stator disc is adjacent a reaction plate containing a plurality of cylindrical, stepped bores defining spring receptacles opening toward the end stator disc and pin guide holes opening in an opposite direction. Each receptacle contains a coil compression spring located between a bottom of the receptacle and a spring retention pin having a first end section reciprocably received in the guide hole and having a second end section defined by a large diameter foot located between an end of the spring and the end stator disc, with the foot being configured for directly engaging the end stator disc. A tool is used to retract the pins and associated springs into the associated receptacles so as to retain the springs during assembly. Excess retraction of the pins is prevented for preventing over-compression of the springs.

### SUMMARY OF THE DISCLOSURE

In an aspect of the present disclosure, a brake assembly for a work machine is provided. The brake assembly includes a main brake housing. The brake assembly also includes a disc stack disposed within a cavity at least partially formed by the main brake housing. The disc stack having a plurality of friction plates and a plurality of separator plates interleaved with the plurality of friction plates. The brake assembly further includes a brake housing coupled with the main brake housing. The brake assembly includes a piston disposed within the cavity and adapted to compress the disc stack. At least one of the main brake housing and the piston define at least two spring pockets. The at least two spring pockets are circumferentially spaced apart from each other. The brake assembly also includes at least two spring assemblies disposed between the main brake housing and the piston. The at least two spring assemblies are adapted to engage the piston with the disc stack to apply brakes via the brake assembly. Each spring pocket of the at least two spring pockets receives a corresponding spring assembly of the at least two spring assemblies. Each of the at least two spring assemblies includes at least one Belleville spring.

In another aspect of the present disclosure, a drivetrain system for a work machine is provided. The drivetrain system includes an axle assembly. The axle assembly includes a differential. The axle assembly also includes an axle shaft. The axle assembly further includes a wheel operably coupled with the differential via the axle shaft. The drivetrain system also includes a transmission system coupled to the axle assembly. The drivetrain system further includes a brake assembly that is operably coupled with a rotatable member of the drivetrain system. The rotatable member includes the axle shaft, the wheel, or the transmission system. The brake assembly includes a main brake housing. The brake assembly also includes a disc stack disposed within a cavity at least partially formed by the main brake housing. The disc stack having a plurality of friction plates and a plurality of separator plates interleaved with the plurality of friction plates. The brake assembly further includes a brake housing coupled with the main brake housing. The brake assembly includes a piston disposed within the cavity and adapted to compress the disc stack. At least one of the main brake housing and the piston define at least two spring pockets. The at least two spring pockets are circumferentially spaced apart from each other. The brake assembly also includes at least two spring assemblies disposed between the main brake housing and the piston. The at least two spring assemblies are adapted to engage the piston with the disc stack to apply brakes via the brake assembly. Each spring pocket of the at least two spring pockets receives a corresponding spring assembly of the at least two spring assemblies. Each of the at least two spring assemblies includes at least one Belleville spring.

In yet another aspect of the present disclosure, a work machine is provided. The work machine includes a chassis. The work machine also includes a drivetrain system coupled to the chassis. The drivetrain system includes an axle assembly. The axle assembly includes a differential. The axle assembly also includes an axle shaft. The axle assembly further includes a wheel operably coupled with the differential via the axle shaft. The drivetrain system also includes a transmission system coupled to the axle assembly. The drivetrain system further includes a brake assembly that is operably coupled with a rotatable member of the drivetrain system. The rotatable member includes the axle shaft, the wheel, or the transmission system. The brake assembly includes a main brake housing. The brake assembly also includes a disc stack disposed within a cavity at least partially formed by the main brake housing. The disc stack having a plurality of friction plates and a plurality of separator plates interleaved with the plurality of friction plates. The brake assembly further includes a brake housing coupled with the main brake housing. The brake assembly includes a piston disposed within the cavity and adapted to compress the disc stack. At least one of the main brake housing and the piston define at least two spring pockets. The at least two spring pockets are circumferentially spaced apart from each other. The brake assembly also includes at least two spring assemblies disposed between the main brake housing and the piston. The at least two spring assemblies are adapted to engage the piston with the disc stack to apply brakes via the brake assembly. Each spring pocket of the at least two spring pockets receives a corresponding spring assembly of the at least two spring assemblies. Each of the at least two spring assemblies includes at least one Belleville spring.

Other features and aspects of this disclosure will be apparent from the following description and the accompanying drawings.

### BRIEF DESCRIPTION OF THE DRAWINGS

FIG. 1 is a schematic perspective view of an exemplary work machine;

FIG. 2 is a schematic perspective view of an axle assembly associated with the work machine of FIG. 1, according to an example of the present disclosure;

FIG. 3 is a schematic perspective view of a final drive associated with the axle assembly of FIG. 2;

FIG. 4 is a schematic perspective view of a brake assembly, according to an example of the present disclosure;

FIG. 5A is a schematic cross-sectional view of the brake assembly of FIG. 4, according to an example of the present disclosure;

FIG. 5B is a schematic view illustrating an arrangement of a number of spring assemblies in the brake assembly of FIG. 4, according to an example of the present disclosure;

FIG. 6 is a schematic cross-sectional view of a single spring assembly associated with the brake assembly of FIG. 4, according to an example of the present disclosure;

FIG. 7 is a schematic cross-sectional view of a first Belleville spring and a second Belleville spring associated with the spring assembly of FIG. 6, according to an example of the present disclosure;

FIG. 8 is a schematic perspective view of a guiding device associated with the spring assembly of FIG. 6, according to an example of the present disclosure;

FIG. 9 is a schematic exploded view of the guiding device of FIG. 8;

FIG. 10 is a schematic cross-sectional view of a single Belleville spring that may be associated with the spring assembly of FIG. 5B, according to another example of the present disclosure; and

FIG. 11 is a schematic cross-sectional view of a brake assembly that may be associated with the final drive of FIG. 3, according to another example of the present disclosure.

### DETAILED DESCRIPTION

Wherever possible, the same reference numbers will be used throughout the drawings to refer to the same or like parts.

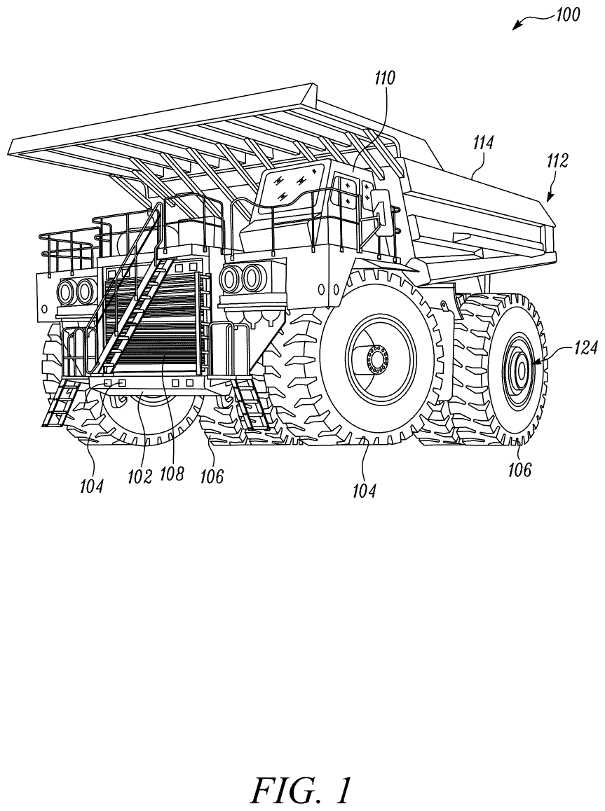

Referring to FIG. 1, a schematic perspective view of a work machine 100 is illustrated. The work machine 100 is embodied as a mining truck that may be used to move a payload, such as, asphalt, debris, dirt, snow, feed, gravel, logs, raw minerals, recycled material, rock, sand, woodchips, etc. from one location to another location. Alternatively, the work machine 100 may be an excavator, a dozer, a wheel loader, a track-type tractor, a motor grader, etc. that may be used for various purposes, such as, excavation, construction, landscaping, and the like, in various industries.

The work machine 100 includes a chassis 102. The chassis 102 supports a pair of front traction devices 104 and a pair of rear traction devices 106 of the work machine 100. The front traction devices 104 and the rear traction devices 106 are embodied as tires herein. The work machine 100 also includes an enclosure 108. The enclosure 108 may house a power source, such as, an engine (for e.g., an internal combustion engine), a battery system, a fuel cell, motors, and the like, to provide power to various components of the work machine 100 for operational and mobility requirements.

The work machine 100 further includes a dump body 112. The dump body 112 includes a box portion 114. The box portion 114 of the dump body 112 may hold the payload. The work machine 100 also includes an operator cabin 110 mounted to the chassis 102. The operator cabin 110 may include one or more controls (not shown) that may enable an operator to control the work machine 100. The operator may be seated within the operator cabin 110 to perform work operations.

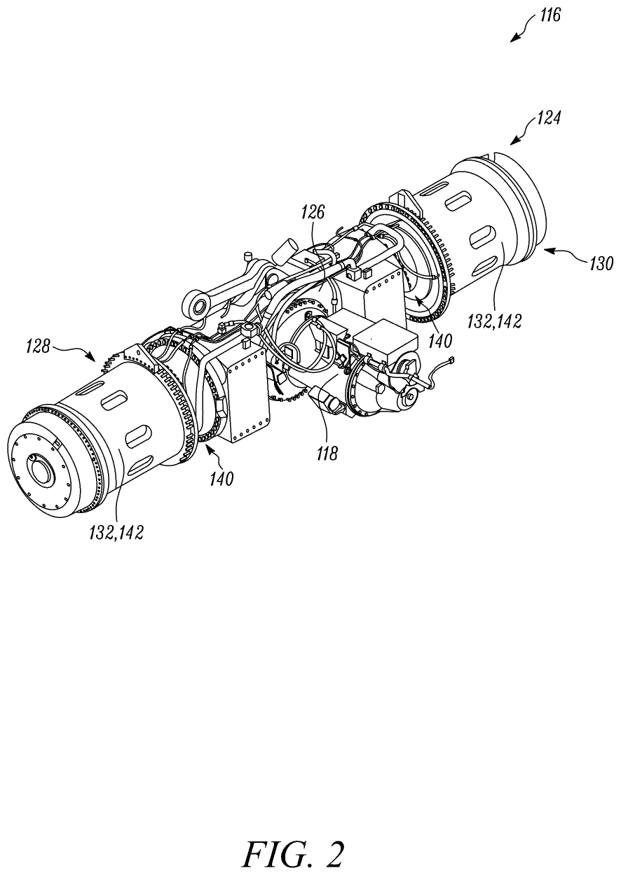

Referring to FIG. 2, the work machine 100 further includes a drivetrain system 116. The drivetrain system 116 is coupled to the chassis 102 (see FIG. 1). The drivetrain system 116 includes an axle assembly 124. The axle assembly 124 is embodied as a rear axle assembly herein that is connected to the rear traction devices 106 (see FIG. 1). The work machine 100 also includes a front axle assembly (not shown) connected to the front traction devices 104 (see FIG. 1). The drivetrain system 116 also includes a transmission system 118 coupled to the axle assembly 124.

The axle assembly 124 includes a differential 126. The axle assembly 124 also includes an axle shaft 140. The axle assembly 124 further includes a wheel 142 operably coupled with the differential 126 via the axle shaft 140. The axle assembly 124 includes a left final drive 128. The axle assembly 124 also includes a right final drive 130 coupled to the left final drive 128 via the differential 126. Each of the left final drive 128 and the right final drive 130 includes a corresponding axle shaft 140 and a corresponding wheel 142 coupled with the axle shaft 140. The differential 126 operatively couples the transmission system 118 with each axle shaft 140. The wheel 142 is drivingly coupled with the differential 126 via the corresponding axle shaft 140, such that a rotation of the axle shaft 140 and the wheel 142 results in a rotation of the corresponding rear traction device 106.

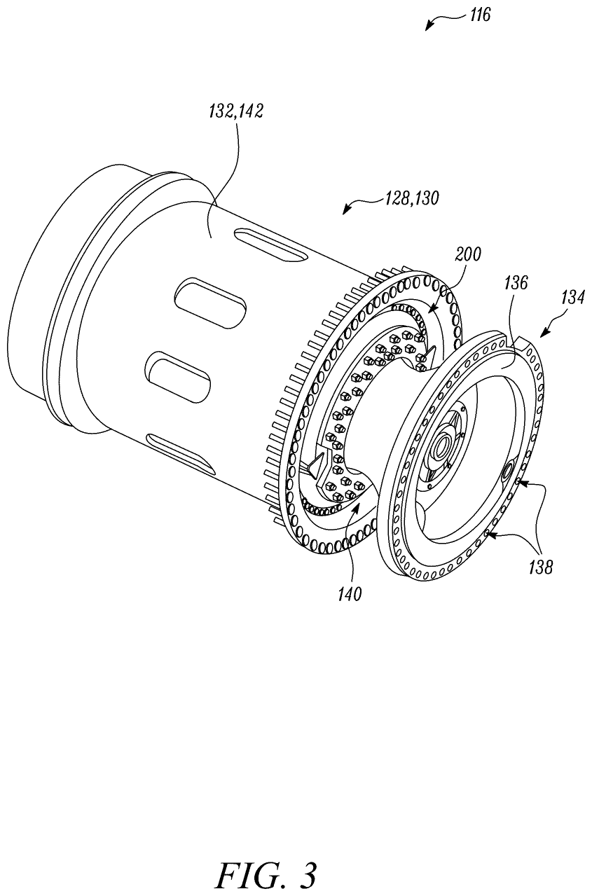

Referring to FIG. 3, a schematic perspective view of the final drive 128, 130 is illustrated. The left final drive 128 and the right final drive 130 are identical to each other. The drivetrain system 116 includes a rotatable member 132. The rotatable member 132 is embodied as the wheel 142 herein. Alternatively, the rotatable member 132 may include the transmission system 118 or the corresponding axle shaft 140 of the left final drive 128 and the right final drive 130.

Each of the left final drive 128 and the right final drive 130 also includes a spindle 134. The spindle 134 includes an annular mounting flange 136 having a number of mounting holes 138. The spindle 134 may be mounted to the chassis 102 (see FIG. 1) by inserting one or more fasteners (not shown) through the mounting holes 138 in the annular mounting flange 136. The drivetrain system 116 further includes a brake assembly 200 that is operably coupled with the rotatable member 132 of the drivetrain system 116. As mentioned above, the rotatable member 132 includes the axle shaft 140, the wheel 142, or the transmission system 118. The brake assembly 200 may resist rotation of the rotatable member 132 relative to the spindle 134.

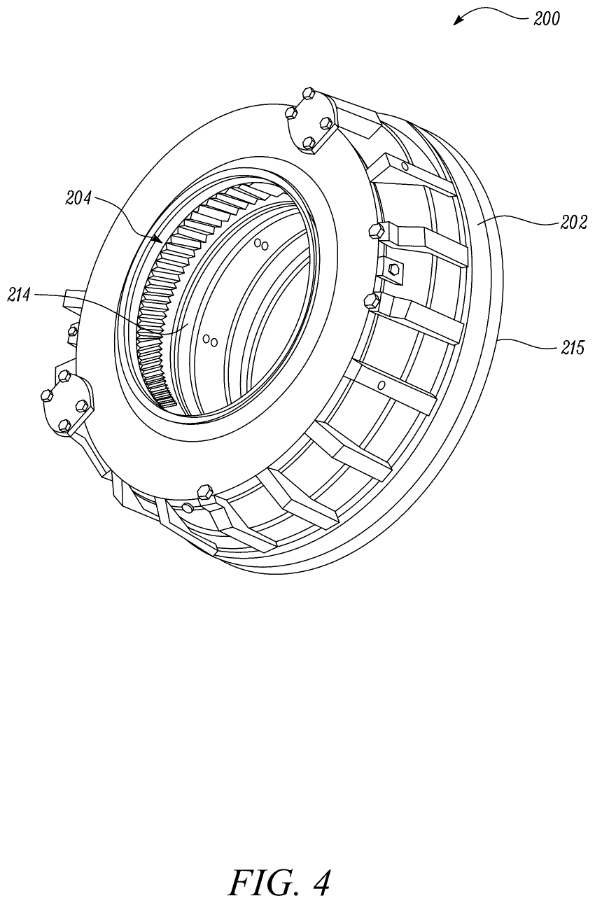

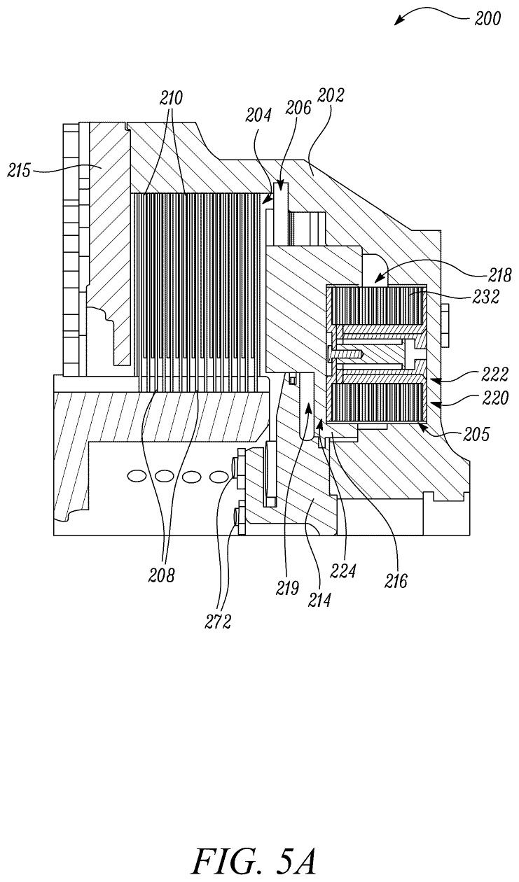

Referring to FIG. 4, a schematic perspective view of the brake assembly 200 is illustrated. Referring to FIG. 5A, a schematic cross-sectional view of the brake assembly 200 of FIG. 4 is illustrated, according to an example of the present disclosure. With reference to FIGS. 4 and 5A, the brake assembly 200 includes a main brake housing 202. The main brake housing 202 may have an annular structure and is fixedly coupled to the spindle 134 (see FIG. 3) via one or more fasteners (not shown).

The brake assembly 200 also includes a disc stack 204 disposed within a cavity 206 at least partially formed by the main brake housing 202. The disc stack 204 has a number of friction plates 208 and a number of separator plates 210 interleaved with the number of friction plates 208. The number of friction plates 208 may be connected to rotate with the rotatable member 132 (see FIG. 3) and the separator plates 210 may be connected to the main brake housing 202. The friction plates 208 may generate a frictional torque that resists rotation of the rotatable member 132.

The brake assembly 200 further includes a reaction plate 215 mounted proximal to the disc stack 204. The reaction plate 215 is a stationary plate which is operatively coupled to the annular mounting flange 136 (see FIG. 3) via the main brake housing 202. The reaction plate 215 may function as an end stop and may create an opposing force that effectively sandwiches the number of friction plates 208 and the separator plates 210.

The brake assembly 200 includes a brake housing 214 coupled with the main brake housing 202. Particularly, the brake housing 214 is coupled with the main brake housing 202 via one or more fasteners 272.

The brake assembly 200 also includes the piston 216 disposed within the cavity 206. The piston 216 compresses the disc stack 204. The piston 216 is disposed within the cavity 206 such that a chamber 219 is defined between the piston 216 and the brake housing 214. Specifically, upon a supply of a pressurized fluid, for example oil, inside the chamber 219, the piston 216 is urged away from the disc stack 204, thereby releasing the disc stack 204 from axial forces.

The main brake housing 202 and/or the piston 216 define two or more spring pockets 205 (only one of which is shown in FIG. 5A). The two or more spring pockets 205 are circumferentially spaced apart from each other.

The brake assembly 200 further includes two or more spring assemblies 218 disposed between the main brake housing 202 and the piston 216. The two or more spring assemblies 218 engage the piston 216 with the disc stack 204 to apply brakes via the brake assembly 200. In other words, to apply the brakes, the pressurized fluid is not supplied into the chamber 219 that causes the spring assemblies 218 to engage the park piston 216 with the disc stack 204, thus halting the work machine 100. Further, each spring pocket 205 of the two or more spring pockets 205 receives a corresponding spring assembly 218 of the two or more spring assemblies 218. Each of the two or more spring assemblies 218 includes one or more Belleville springs 232.

In some examples, when the work machine 100 includes a service brake assembly, the piston 216 is a service piston that is used to apply service brakes via the brake assembly 200. For example, the spring assembly 218 may be disposed in the service brake assembly associated with work machines that only include service brakes. In such cases, the spring assembly 218 may be disposed in spring pockets defined in a service piston and/or a main brake housing of the said service brake assembly.

In some examples, when the work machine 100 includes a park brake assembly, the piston 216 is a park piston that is used to apply park brakes via the brake assembly 200. For example, the spring assembly 218 may be disposed in the park brake assembly associated with work machines that only include park brakes. In such cases, the spring assembly 218 may be disposed in spring pockets defined in a park piston and/or a main brake housing of the said park brake assembly.

Referring now to FIG. 5B, in an exemplary embodiment, the two or more spring pockets 205 include eighteen spring pockets 205. In other words, the brake assembly 200 include eighteen spring pockets 205 that are circumferentially spaced apart from each other. It should be noted that an orientation and/or arrangement of the spring pockets 205 may vary as per application requirements. Further, in the example illustrated in FIG. 5B, the two or more spring assemblies 218 include eighteen spring assemblies 218. In other words, the brake assembly 200 include eighteen spring assemblies 218. Each spring pocket 205 receives a corresponding spring assembly 218. However, the brake assembly 200 may include any number of spring pockets 205 and corresponding spring assemblies 218, as per application requirements.

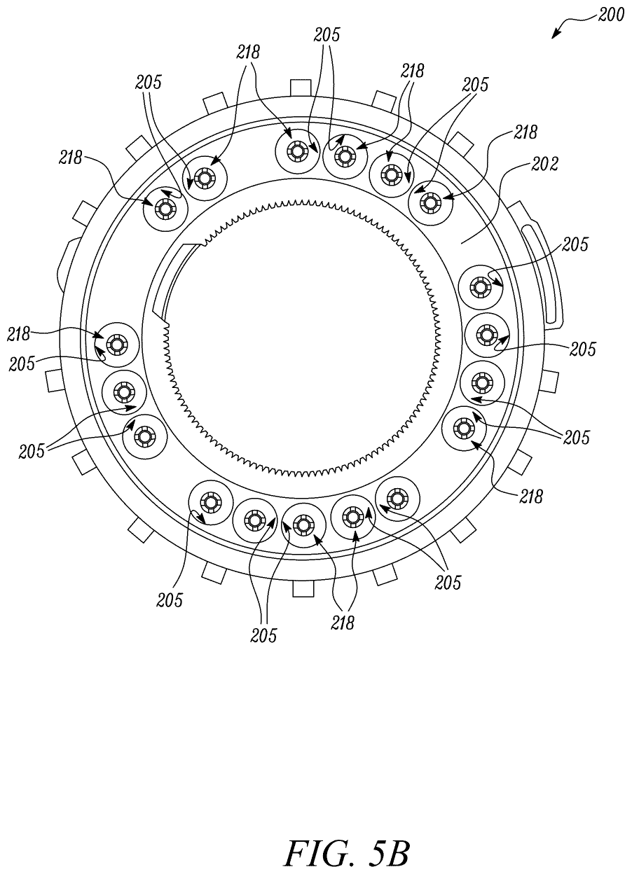

Referring to FIG. 6, a schematic cross-sectional view of the spring assembly 218 is illustrated. With reference to FIGS. 5A, 5B, and 6, each of the two or more spring assemblies 218 includes a guiding device 220 defining a first end 222 disposed proximal to the main brake housing 202 and a second end 224 disposed proximal to the piston 216. The guiding device 220 includes a first flange 226 at the first end 222, a second flange 228 at the second end 224, and a guiding surface 230 extending between the first end 222 and the second end 224.

In some examples, the one or more Belleville springs 232 includes a number of pairs of Belleville springs 234. Further, when each spring assembly 218 includes the number of pairs of Belleville springs 234, the spring pocket 205 (see FIGS. 5A and 5B) may be partially formed in the main brake housing 202 (see FIG. 5A) and partially formed in the piston 216 (see FIG. 5A). It should be noted that the guiding device 220 is required only when the multiple pairs of Belleville springs 234 are to be disposed in the spring pocket 205.

The number of pairs of Belleville springs 234 are coupled to the guiding device 220. In the illustrated example of FIG. 6, nine pairs of Belleville springs 234 are shown as an example. Alternatively, the spring assemblies 218 may include any number of pairs of Belleville springs 234, based on application attributes. The number of pairs of Belleville springs 234 are axially disposed between the first flange 226 and the second flange 228 of the guiding device 220. Further, the number of pairs of Belleville springs 234 are circumferentially disposed around the guiding surface 230 of the guiding device 220.

Each of the number of pairs of Belleville springs 234 includes one or more first Belleville springs 236 and one or more second Belleville springs 238 disposed axially adjacent to the one or more first Belleville springs 236. In the example illustrated in FIG. 6, the one or more first Belleville springs 236 includes a single first Belleville spring 236 and the one or more second Belleville springs 238 includes a single second Belleville springs 238. In the example illustrated in FIG. 6, the first Belleville spring 236 and the second Belleville spring 238 are disposed in a series arrangement. In another example, the first Belleville spring 236 and the second Belleville spring 238 may disposed in a parallel arrangement.

In yet another example, each of the number of pairs of Belleville springs 234 may be arranged in a series and parallel arrangement. For example, the one or more first Belleville springs 236 may include two first Belleville springs 236 arranged in a parallel arrangement, and the one or more second Belleville springs 238 may include two second Belleville springs 238 arranged in a parallel arrangement. Further, the two first Belleville springs 236 and the two second Belleville springs 238 may be in turn disposed in a series arrangement with each other.

It should be noted that the present disclosure is not limited to a technique of arranging the one or more Belleville springs 232. Accordingly, any other technique may be used to arrange the one or more Belleville springs 232, without limiting the scope of the present disclosure.

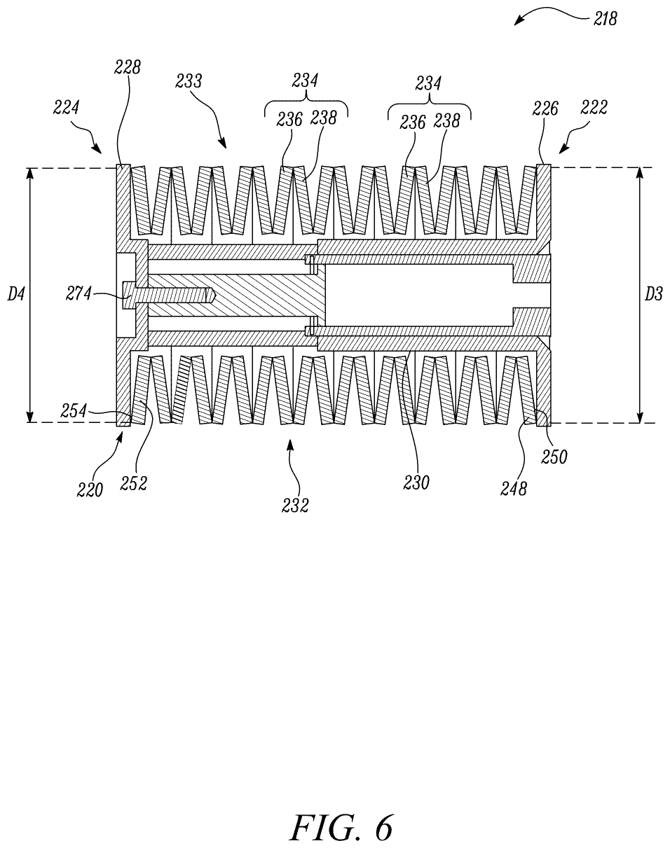

Referring to FIG. 7, a schematic cross-sectional view of the first Belleville spring 236 and the second Belleville spring 238 is illustrated. Each first Belleville spring 236 includes a first end portion 240 defining a first maximum diameter D1 and a second end portion 242 defining a first minimum diameter L1. Each second Belleville spring 238 includes a third end portion 244 defining a second maximum diameter D2 and a fourth end portion 246 defining a second minimum diameter L2. The second maximum diameter D2 is equal to the first maximum diameter D1 and the second minimum diameter L2 is equal to the first minimum diameter L1. As shown in FIG. 7, each of the number of pairs of Belleville springs 234 is arranged such that the first end portion 240 of the first Belleville spring 236 engages with the third end portion 244 of the second Belleville spring 238.

Referring again to FIGS. 5A and 6, the one or more Belleville springs 232 further includes a first end-Belleville spring 248 disposed at one end of the number of pairs of Belleville springs, 234. Specifically, the one or more Belleville springs 232 further includes the first end-Belleville spring 248 disposed adjacent to the first flange 226 of the guiding device 220. The first end-Belleville spring 248 includes an end portion 250 defining a maximum diameter D3. The first end-Belleville spring 248 is disposed such that the end portion 250 engages with the first flange 226 of the guiding device 220.

The one or more Belleville springs 232 further includes a second end-Belleville spring 252 disposed at another end of the number of pairs of Belleville springs 234. Specifically, the one or more Belleville springs 232 further includes the second end-Belleville spring 252 disposed adjacent to the second flange 228 of the guiding device 220. The second end-Belleville spring 252 includes an end portion 254 defining a maximum diameter D4. The second end-Belleville spring 252 is disposed such that the end portion 254 engages with the second flange 228 of the guiding device 220. Thus, in such examples, the one or more Belleville springs 232 includes a spring stack 233. The spring stack 233 includes the number of pairs of Belleville springs 234, the first end-Belleville spring 248 disposed at one end of the plurality of pairs of Belleville springs 234, and the second end-Belleville spring 252 disposed at another end of the plurality of pairs of Belleville springs 234. Overall, each spring assembly 218 includes 20 Belleville springs in total.

It should be noted that each of the first Belleville spring 236, the second Belleville spring 238, the first end-Belleville spring 248, and the second end-Belleville spring 252 are substantially similar to each other in design, dimensions, and functionality. Accordingly, each of the first maximum diameter D1, the second maximum diameter D2, the maximum diameter D3, and the maximum diameter D4 is equal.

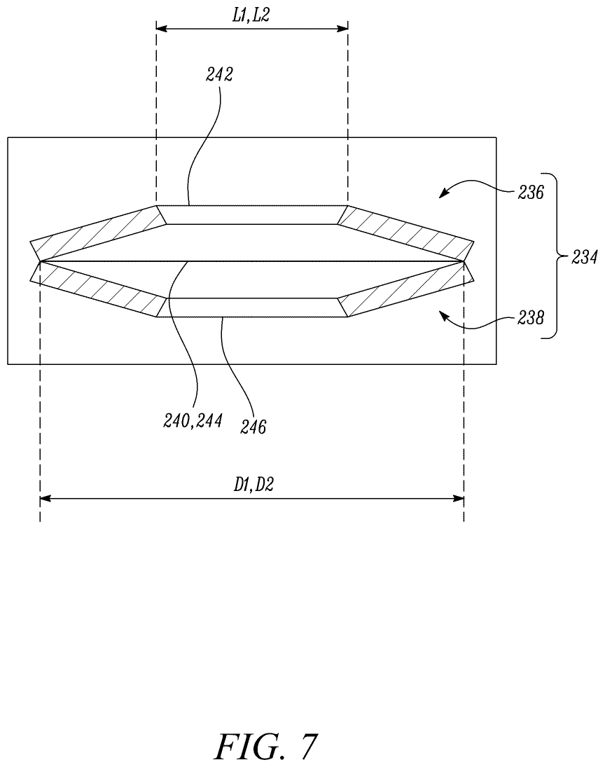

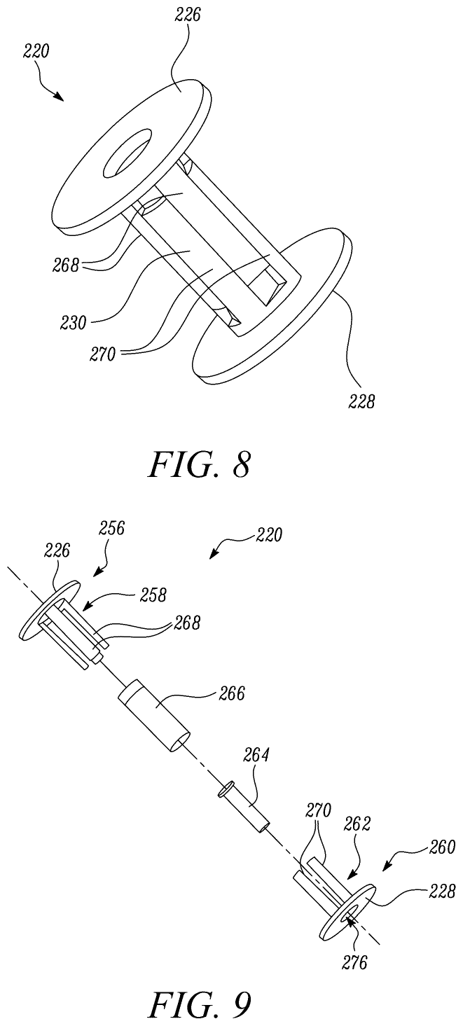

Referring to FIG. 8, a schematic perspective view of the guiding device 220 is illustrated. Referring to FIG. 9, a schematic exploded view of the guiding device 220 of FIG. 8 is illustrated. With reference to FIGS. 8 and 9, the guiding device 220 includes a first end member 256 extending from the first end 222 (see FIG. 5A) towards the second end 224 (see FIG. 5A). The first end member 256 includes the first flange 226 and a first body 258 axially extending from the first flange 226. The first body 258 of the first end member 256 includes a number of first arcuate plates 268 circumferentially spaced apart from each other. In the illustrated example of FIGS. 8 and 9, the first body 258 includes four first arcuate plates 268. In other examples, the first body 258 may include any number of first arcuate plates 268, based on application attributes.

The guiding device 220 also includes a tubular member 266 concentrically disposed within the first end member 256. The guiding device 220 further includes a second end member 260 extending from the second end 224 towards the first end 222 and coupled with the first end member 256. The second end member 260 includes the second flange 228 and a second body 262 axially extending from the second flange 228. The second body 262 of the second end member 260 includes a number of second arcuate plates 270 circumferentially spaced apart from each other. The second end member 260 defines a hole 276. In the illustrated example of FIG. 9, the second body 262 includes four second arcuate plates 270. In other examples, the second body 262 may include any number of second arcuate plates 270, based on application attributes. In an assembled condition of the guiding device 220, each second arcuate plate 270 is circumferentially disposed between a pair of first arcuate plates 268.

The first body 258 of the first end member 256 and the second body 262 of the second end member 260 together define the guiding surface 230 of the guiding device 220. In other words, the first arcuate plates 268 and the second arcuate plates 270 together define the guiding surface 230.

The guiding device 220 includes a movable member 264 coupled to the second end member 260 and at least partially disposed within the tubular member 266. The movable member 264 axially moves between the first flange 226 and the second flange 228 based on an extension and a retraction of the one or more Belleville springs 232 (see FIG. 5A). In some examples, the movable member 264 may include a piston, a rod, and the like that may reciprocate between the first flange 226 and the second flange 228.

The guiding device 220 further includes a fastening means 274 (see FIG. 6). The fastening means 274 couples the second end member 260 with the movable member 264. The hole 276 in the second end member 260 at least partially receives the fastening means 274. The fastening means 274 may also allow an operator to set a height of the number of Belleville springs 234 (FIG. 6) during packaging of the spring assemblies 218 (see FIG. 6). In some examples, the fastening means 274 may be a bolt, a screw, a rivet, and the like, without limiting the scope of the present disclosure.

In order to assemble the guiding device 220, the movable member 264 is assembled with the second end member 260 via the fastening means 274. Specifically, the movable member 264 is inserted between the second arcuate plates 270 and is assembled with the second end member 260 via the fastening means 274. Further, the tubular member 266 is press fitted into the first end member 256. Specifically, the tubular member 266 is press fitted with the first arcuate plates 268 of the first end member 256. The Belleville springs 234, 248, 252 are then assembled with the first arcuate plates 268 of the first end member 256 and the tubular member 266. Further, the movable member 264 and the second end member 260 are assembled with the tubular member 266 and the first end member 256 such that each second arcuate plate 270 is circumferentially disposed between the pair of first arcuate plates 268 and the number of pair of Belleville springs 234 is disposed between the first flange 226 of the first end member 256 and the second flange 228 of the second end member 260. It should be noted that a design of the guiding device 220 as shown and explained herein is exemplary in nature, and the guiding device 220 may include any other design or arrangement of components.

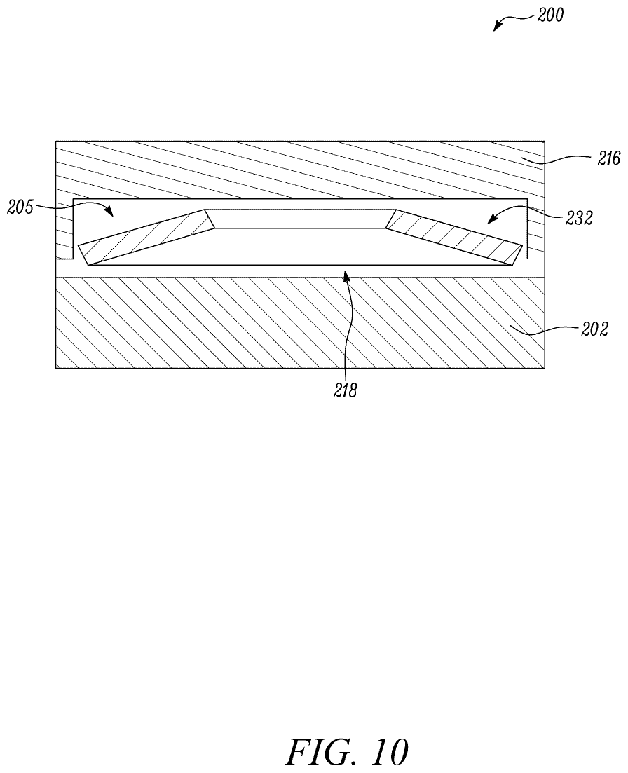

FIG. 10 is a schematic cross-sectional view of the spring assembly 218 that may be associated with the brake assembly 200 of FIG. 5A, according to another example of the present disclosure. In the example illustrated in FIG. 10, the one or more Belleville springs 232 includes a single Belleville spring 232. In other words, the spring assembly 218 is made of the single Belleville spring 232. Further, when each spring assembly 218 includes the single Belleville spring 232, the spring pocket 205 may be formed in the main brake housing 202 or the piston 216. In the illustrated example of FIG. 10, the spring pocket 205 is formed in the piston 216. Alternatively, the spring pocket 205 may be formed in the main brake housing 202. It should be noted that the spring assembly 218 does not include the guiding device 220 (see FIG. 5A) when only the single Belleville spring 232 is to be disposed in the spring pocket 205. In such examples, the guiding device 220 may be omitted.

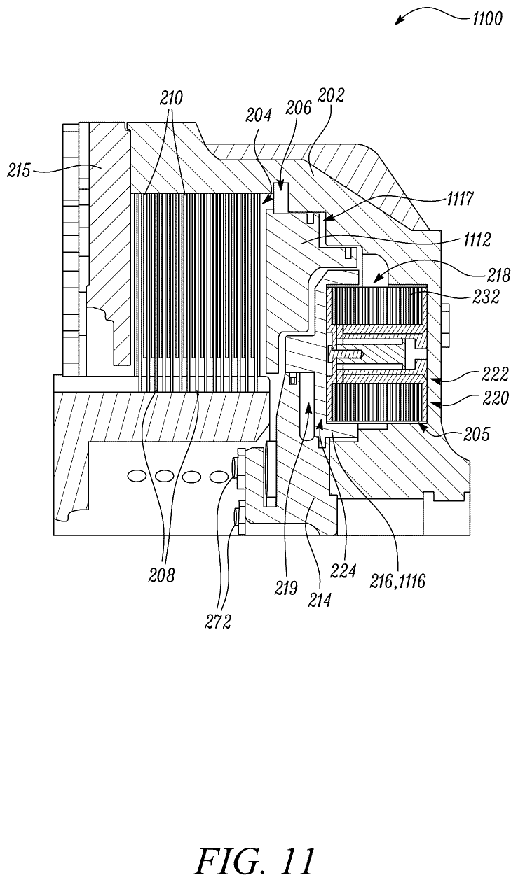

Referring to FIG. 11, a schematic cross-sectional view of a brake assembly 1100 that may be associated with the final drive 128, 130 of FIG. 3 is illustrated, according to another example of the present disclosure. The brake assembly 1100 is substantially similar to the brake assembly 200 (see FIG. 5A) with common components being referred to by the same numerals. However, the piston 216 is a park piston 1116. Further, the brake housing 214 is a park brake housing. The park piston 1116 is disposed within the cavity 206 such that the chamber 219 is defined between the park piston 1116 and the brake housing 214.

The brake assembly 1100 further includes the service piston 1112 disposed within the cavity 206. The service piston 1112 compresses the disc stack 204. The service piston 1112 may have an annular structure. The service piston 1112 is disposed within the cavity 206 such that a second chamber 1117 is defined between the service piston 1112 and the main brake housing 202. Specifically, upon a supply of a pressurized fluid, for example oil, inside the second chamber 1117, the service piston 1112 is urged towards the reaction plate 215, thereby compressing the disc stack 204. It should be noted that, a pressure of fluid within the second chamber 1117 may relate to a magnitude of the frictional torque resisting the rotation of the rotatable member 132.

The park piston 1116 selectively engages with the service piston 1112. Specifically, upon the supply of the pressurized fluid inside the chamber 219, the park piston 1116 is urged away from the service piston 1112, thereby releasing the disc stack 204 from axial forces.

The brake assembly 1100 further includes two or more spring assemblies 218 disposed between the main brake housing 202 and the park piston 1116. The two or more spring assemblies 218 engage the park piston 1116 with the service piston 1112 to apply park brakes via the brake assembly 1100. In some examples, the two or more spring assemblies 218 engage the park piston 1116 with the service piston 1112 to position the work machine 100 in a parked state. In other words, to position the work machine 100 in the parked state, the pressurized fluid is not supplied into the chamber 219 that causes the spring assemblies 218 to engage the park piston 1116 with the service piston 1112, thus compressing the disc stack 204 and braking the work machine 100.

It is to be understood that individual features shown or described for one embodiment may be combined with individual features shown or described for another embodiment. The above described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

### INDUSTRIAL APPLICABILITY

The present disclosure relates to the brake assembly 200, 1100 including the two or more spring assemblies 218. Each spring assembly 218 includes the one or more Belleville springs 232. In some examples, the one or more Belleville springs 232 includes the single Belleville spring 232. In another example, the one or more Belleville springs 232 includes multiple Belleville springs, i.e., the Belleville springs 234, 248, 252. The number of pairs of Belleville springs 234, 248, 252 are axially disposed between the first flange 226 and the second flange 228 of the guiding device 220. The Belleville springs 232 have a higher biasing force thereby providing increased braking force to position the work machine 100 in the parked state at steep gradients as compared to conventional coil springs. In an example, the Belleville springs 232 assembled in the spring pockets 205 may meet regulations and standards of braking requirements, such as, grade holding, stopping distance, deceleration, and the like.

Further, during a braking operation, when the number of friction plates 208 in the disc stack 204 wear, the Belleville springs 232 disposed in the spring pockets 205 may generate a sufficient amount of force to push the piston 216 in order to meet the braking requirements of the work machine 100.

Further, the Belleville springs 232 may allow retract pressure and touch-up pressure requirements to be within a specified range and may not add extra loads on the components for example seals, associated with the brake assembly 200, 1100. Furthermore, the Belleville springs 232 disposed in the spring pockets 205 may have less weight and size as compared to conventional coil springs, thereby reducing weight of the brake assembly 200, 1100. The spring assemblies 218 may be accommodated in existing brake assemblies to meet the service brake and/or park brake requirements, without affecting geometry of existing features, such as, actuation ports or cooling oil passages of the brake assembly 200, 1100, while retaining an efficiency of the brake assembly 200, 1100.

Moreover, the brake assembly 200, 1100 may reduce a number of additional components required, such as, pistons and housings, and may lead to improvement in manufacturing efficiency of the brake assembly 200, 1100. The brake assembly 200, 1100 of the present disclosure may be light in weight, may improve holding requirements, and performance of the work machine 100. Further, the incorporation of the Belleville springs 232 disposed in the spring pockets 205 may allow the brake assembly 200, 1100 to meet the service brake and/or park brake requirements in a cost-effective manner. The spring assembly 218 described herein may be incorporated in brake assemblies that include service brakes and park brakes, as well as in brake assemblies that include any one of the service brakes and the park brakes.

While aspects of the present disclosure have been particularly shown and described with reference to the embodiments above, it will be understood by those skilled in the art that various additional embodiments may be contemplated by the modification of the disclosed work machine, systems and methods without departing from the spirit and scope of the disclosure. Such embodiments should be understood to fall within the scope of the present disclosure as determined based upon the claims and any equivalents thereof.

What is claimed is:

1. A brake assembly for a work machine, the brake assembly comprising:
a main brake housing;
a disc stack disposed within a cavity at least partially formed by the main brake housing, the disc stack having a plurality of friction plates and a plurality of separator plates interleaved with the plurality of friction plates;
a brake housing coupled with the main brake housing;
a piston disposed within the cavity and adapted to compress the disc stack, wherein at least one of the main brake housing and the piston define at least two spring pockets, and wherein the at least two spring pockets are circumferentially spaced apart from each other; and
at least two spring assemblies disposed between the main brake housing and the piston, and adapted to engage the piston with the disc stack to apply brakes via the brake assembly, wherein each spring pocket of the at least two spring pockets receives a corresponding spring assembly of the at least two spring assemblies, and wherein each of the at least two spring assemblies includes at least one Belleville spring.

2. The brake assembly of claim 1, wherein the piston is a service piston that is used to apply service brakes via the brake assembly or a park piston that is used to apply park brakes via the brake assembly.

3. The brake assembly of claim 1, wherein the piston is a park piston, and wherein the brake assembly further includes a service piston disposed within the cavity and adapted to compress the disc stack, wherein the park piston is adapted to selectively engage with the service piston, and wherein the at least two spring assemblies are adapted to engage the park piston with the service piston to apply park brakes via the brake assembly.

4. The brake assembly of claim 1, wherein each of the at least two spring assemblies further includes a guiding device defining a first end disposed proximal to the main brake housing and a second end disposed proximal to the piston, wherein the guiding device includes a first flange at the first end, a second flange at the second end, and a guiding surface extending between the first end and the second end.

5. The brake assembly of claim 4, wherein the at least one Belleville spring includes a plurality of pairs of Belleville springs, wherein the plurality of pairs of Belleville springs are coupled to the guiding device, wherein the plurality of pairs of Belleville springs are axially disposed between the first flange and the second flange of the guiding device, and circumferentially disposed around the guiding surface of the guiding device, and wherein each of the plurality of pairs of Belleville springs includes at least one first Belleville spring and at least one second Belleville spring disposed axially adjacent to the at least one first Belleville spring.

6. The brake assembly of claim 4, wherein the at least one Belleville spring further includes:
a first end-Belleville spring disposed adjacent to the first flange of the guiding device; and
a second end-Belleville spring disposed adjacent to the second flange of the guiding device.

7. The brake assembly of claim 1, wherein the at least two spring pockets include eighteen spring pockets, and wherein the at least two spring assemblies include eighteen spring assemblies.

8. The brake assembly of claim 1, wherein the at least one Belleville spring includes a single Belleville spring.

9. A drivetrain system for a work machine, the drivetrain system comprising:
an axle assembly including:
a differential;
an axle shaft; and
a wheel operably coupled with the differential via the axle shaft;
a transmission system coupled to the axle assembly; and
a brake assembly that is operably coupled with a rotatable member of the drivetrain system, wherein the rotatable member includes the axle shaft, the wheel, or the transmission system, the brake assembly including:
a main brake housing;
a disc stack disposed within a cavity at least partially formed by the main brake housing and the rotatable member, the disc stack having a plurality of friction plates and a plurality of separator plates interleaved with the plurality of friction plates, wherein the plurality of friction plates are operatively coupled to the rotatable member and the plurality of separator plates are operatively coupled to the main brake housing;
a brake housing coupled with the main brake housing;
a piston disposed within the cavity and adapted to compress the disc stack, wherein at least one of the main brake housing and the piston define at least two spring pockets, and wherein the at least two spring pockets are circumferentially spaced apart from each other; and
at least two spring assemblies disposed between the main brake housing and the piston, and adapted to engage the piston with the disc stack to apply brakes via the brake assembly, wherein each spring pocket of the at least two spring pockets receives a corresponding spring assembly of the at least two spring assemblies, and wherein each of the at least two spring assemblies includes at least one Belleville spring.

10. The drivetrain system of claim 9, wherein the piston is a service piston that is used to apply service brakes via the brake assembly or a park piston that is used to apply park brakes via the brake assembly.

11. The drivetrain system of claim 9, wherein the piston is a park piston, and wherein the brake assembly further includes a service piston disposed within the cavity and adapted to compress the disc stack, wherein the park piston is adapted to selectively engage with the service piston, and wherein the at least two spring assemblies are adapted to engage the park piston with the service piston to apply park brakes via the brake assembly.

12. The drivetrain system of claim 9, wherein each of the at least two spring assemblies further includes a guiding device defining a first end disposed proximal to the main brake housing and a second end disposed proximal to the piston, and wherein the guiding device includes a first flange at the first end, a second flange at the second end, and a guiding surface extending between the first end and the second end.

13. The drivetrain system of claim 12, wherein the at least one Belleville spring includes a plurality of pairs of Belleville springs, wherein the plurality of pairs of Belleville springs are coupled to the guiding device, wherein the plurality of pairs of Belleville springs are axially disposed between the first flange and the second flange of the guiding device, and circumferentially disposed around the guiding surface of the guiding device, and wherein each of the plurality of pairs of Belleville springs includes at least one first Belleville spring and at least one second Belleville spring disposed axially adjacent to the at least one first Belleville spring.

14. The drivetrain system of claim 12, wherein the at least one Belleville spring further includes:
a first end-Belleville spring disposed adjacent to the first flange of the guiding device; and
a second end-Belleville spring disposed adjacent to the second flange of the guiding device.

15. The drivetrain system of claim 9, wherein the at least two spring pockets include eighteen spring pockets, and wherein the at least two spring assemblies include eighteen spring assemblies.

16. The drivetrain system of claim 9, wherein the at least one Belleville spring includes a single Belleville spring.

17. A work machine comprising:
a chassis; and
a drivetrain system coupled to the chassis, the drivetrain system including:
an axle assembly including:
a differential;
an axle shaft; and
a wheel operably coupled with the differential via the axle shaft;
a transmission system coupled to the axle assembly; and
a brake assembly that is operably coupled with a rotatable member of the drivetrain system, wherein the rotatable member includes the axle shaft, the wheel, or the transmission system, the brake assembly including:
a main brake housing;
a disc stack disposed within a cavity at least partially formed by the main brake housing and the rotatable member, the disc stack having a plurality of friction plates and a plurality of separator plates interleaved with the plurality of friction plates, wherein the plurality of friction plates are operatively coupled to the rotatable member and the plurality of separator plates are operatively coupled to the main brake housing;
a brake housing coupled with the main brake housing;
a piston disposed within the cavity and adapted to compress the disc stack, wherein at least one of the main brake housing and the piston define at least two spring pockets, and wherein the at least two spring pockets are circumferentially spaced apart from each other; and
at least two spring assemblies disposed between the main brake housing and the piston, and adapted to engage the piston with the disc stack to apply brakes via the brake assembly, wherein each spring pocket of the at least two spring pockets receives a corresponding spring assembly of the at least two spring assemblies, and wherein each of the at least two spring assemblies includes at least one Belleville spring.

18. The work machine of claim 17, wherein the piston is a service piston that is used to apply service brakes via the brake assembly or a park piston that is used to apply park brakes via the brake assembly.

19. The work machine of claim 17, wherein the piston is a park piston, and wherein the brake assembly further includes a service piston disposed within the cavity and adapted to compress the disc stack, wherein the park piston is adapted to selectively engage with the service piston, and wherein the at least two spring assemblies are adapted to engage the park piston with the service piston to apply park brakes via the brake assembly.

20. The work machine of claim 17, wherein the at least one Belleville spring includes:
a spring stack including a plurality of pairs of Belleville springs, a first end-Belleville spring disposed at one end of the plurality of pairs of Belleville springs, and a second end-Belleville spring disposed at another end of the plurality of pairs of Belleville springs; or
a single Belleville spring.
